(19) United States
(12) Patent Application Publication
(10) Pub. No.: US 2021/0149887 A1
(43) Pub. Date: May 20, 2021

(54) Methods and Systems for Creating Design Compositions from Natural Linguistic or Discrete Decision Input

(71) Applicants: Sarah-Eva Ellen Marchese, Rockford, IL (US); Nathan Joseph Marchese, Rockford, IL (US)

(72) Inventors: Sarah-Eva Ellen Marchese, Rockford, IL (US); Nathan Joseph Marchese, Rockford, IL (US)

(21) Appl. No.: 17/099,766

(22) Filed: Nov. 16, 2020

Related U.S. Application Data
(60) Provisional application No. 62/936,404, filed on Nov. 16, 2019.

(51) Int. Cl. G06F 16/242; G06F 16/2457; G06F 40/20

(52) U.S. Cl. CPC G06F 16/243; G06F 40/20; G06F 16/24573

(57) ABSTRACT

The invention is directed to systems, methods, and apparatus for producing a design for a creative composition based on personal or natural language input. The system solicits natural language input. That input is + correlated with certain design criteria. Using such solicited inputs, the system selects appropriate design criteria correlated with those responses and other compatible design elements and returns a complete design for the user's approval.

### CROSS-REFERENCE TO RELATED APPLICATIONS

This application claims the benefit of U.S. Provisional Application No. 62/936,404; filed Nov. 16, 2019.

### COPYRIGHT NOTICE

A portion of this patent document's disclosure contains material that is subject to copyright protection. The copyright owner does not object to the facsimile reproduction by anyone of the patent document or the patent disclosure as it appears in the Patent and Trademark Office patent file or records, but otherwise reserves all copyright rights.

### BACKGROUND OF THE INVENTION

### 1. Field of the Invention

The invention is directed toward the field of commercial creative composition. More specifically, the invention is directed toward the consumption of commissioned creative compositions personalized to a consumer based on natural language input from the user.

### 2. Background of the Invention

a. The Demand for Personalized Creative Compositions

There is a strong demand for personalized creative compositions in a variety of aspects of their lives, from events to home decor to personal attire. Particularly in the field of gifting, there is strong demand for gifts that feel unique and personal to the giver and the recipient. This is particularly true when a gift is intended to build or reflect the relationship between the giver and recipient.

Unfortunately, patrons of customized compositions are often met with a number of limitations in the current technology. Primary amongst those are the issues that givers often lack the knowledge and skill to design and execute a creative composition that is personal to their relationship with a recipient and is also of a satisfactory professional, or otherwise satisfactory, standard of craftsmanship in planning or execution. Furthermore, givers often find themselves at a loss to determine how to make a gift effectively feel personal to the recipient so as to achieve the goal of effectively establishing a level of connection appropriate and reflective of the nature of the relationship. And predesigned or standardized creations are not adequate substitutes as they fail to offer the same means for the giver to impart personalized sentiment.

This problem stems from several issues. One is the many givers' lack of expertise within the sphere of craftsmanship or design relevant to the creative composition to be designed. Another is a giver's lack of time or creative impetus to develop a satisfactory design, particularly in a field that is relatively unfamiliar. A third issue is a user's lack of self-confidence with respect to the creative field of invention. There are further issues, but these illustrate the dilemmas the average layperson confronts when seeking to design a personal and unique creative composition.

b. Problems in Representative Field: Custom Floral Design

One field of creative composition which exemplifies both the ubiquity and nature of the problems surrounding creative composition and the inadequacy of existing solutions to the problem is the field of floral design, particularly with respect to customized floral arrangements either for gifting or event decor.

A 2009 study by the Society of American Florists indicates that younger generations, specifically the millennial generation, see flowers as a means of articulating their personal style both at home and in their weddings. They see flowers as a way to enhance the style associated with their broader tastes or styles as expressed in their personal attire, home décor, and general views on life. Further, there is a strong demand that this personalized expression feel unique as opposed to a “cookie-cutter” arrangement or one using common design aspects or features lacking individual features to distinguish it from previous designs while maintaining a look and feel representative of the individual's personal style.

For the first time in 2010, florists made it to Angie's List's top ten industries engendering the most complaints from customers. Follow-up surveys indicated that 85% of respondents had used florists for pre-made or customized arrangements. But 43% of those reported having more negative than positive experiences with florists.

A major cause of dissatisfaction among millennial flower consumers, and the flower consuming public generally, is the sense that customized floral arrangements fail to meet their expectations or to appropriately match their personal style.

c. Existing Solutions in Representative Field: Floral Arrangement Imaging Technologies

A number of services create visual representations of flower arrangements that a user can alter to create a customized virtual arrangement design. Such technologies have been disclosed in, for example, U.S. Pat. No. 5,440,479 (a floral kiosk ordering system with visual ordering information), U.S. Pat. No. 7,337,413 B1 (a system and method for designing a bouquet from selected images); U.S. Pat. No. 8,954,875 B2 (a method for providing a visual representation of floral arrangements by arranging selected images into templates); United States Patent Application Publications US 2006/0064314 A1 (a graphical user interface which combines images of selecting floral items); US 2009/0063302 A1 (a floral arrangement marketplace featuring a what-you-see-is-what-you-get interface displaying floral arrangements composed of selected images); US 2012/0198387 A1 (a computer-implemented method and tool for creating a virtual floral arrangement); US 2015/0019368 A1 (a floral arrangement customization system allowing a user to create and modify a customized floral arrangement); and World Intellectual Property Organization Patent WO 2012/005385 A1 (a method for customizing online flowers involving creation of a customized bouquet image). Comparable instantiations of these visual arrangement development tools are available online at Russian Flora (www.russianflora.com/bouquet-builder.php); the website of Interflora's United Kingdom affiliate (www.interflora.co.uk/myinterfloracreation.xml); Designed by the Bride (designedbythebride.com/you-design/free-editor/); and centralpark.com (www.centralpark.com/virtual-bouquet/create).

While each of the above-listed solutions provides a means to visually arrange flower images into various combinations and configurations, these solutions do not address the above-referenced issues of lack of design skill, lack of confidence, and lack of any starting point to create a strongly personal nature to the design reflecting the relationship of the giver and the recipient. Nor do the above-listed solutions provide guidance to a user seeking to arrange by the symbolic meaning of the flowers in question, rather than basing a design purely on aesthetic criteria.

Each of these solutions puts the user directly into the position of a designer with little to no education or guidance. The user is expected to interact directly with the positioning of design components such as flowers and accessories, which the layperson has no prior expertise in. Users have no means to confidently say whether their designs will look good. Further, there is no meaningful assistance in selecting which components to include in the design either on an aesthetic or symbolic level. Nor is there any clear superiority of this solution over commissioning a design from a local florist or craftsman. Finally, it is not necessarily apparent that these solutions provide any craftsmanship component to actually deliver on a completed design.

Even where, in some solutions, user choices are guided or limited based on principles of floral design, these are still presented from the perspective of an individual seeking to engage in floral design, rather than a layperson seeking an arrangement to convey a particular message, satisfy a general aesthetic, or adequately fit a specific role. For example, even where, at most, one of the existing disclosed systems provides some guardrails based on principles of floristry guidelines, these still do not meet a layperson at the level they seek to design, if that is to create an aesthetically pleasing arrangement with plants that symbolize “friendship,” or create an arrangement that will be an effective table centerpiece in a modern dining room.

Instead, these solutions rely on the user to sufficiently understand design principles to create an arrangement in their look and feel themselves, with no information or guidance, which is inadequate for casual consumers without a strong basis in floral design expertise.

d. State of the Art—Horticultural Decorative Plant Indexing and Searching Services

While existing solutions for decorative plant searching, inventory, and provision tend to narrow the field of searchable or identifiable plants, there are solutions focused on the horticultural arts which provide access to expansive flower collections, beyond those available in the above-described solutions. These solutions tend to focus on the identification of unknown plant species and genera and the conditions necessary for individuals to cultivate flowers themselves. However, several limitations of such systems limit their utility to individuals interested in personalized design composition.

One example of a horticultural tool for plant identification is provided through Aerulean (www.aerulean.com/). This tool permits flower searches by plant name or country. It allows users to refine searches by identifying a variety of horticultural characteristics, such as growing condition requirements, flower shape and formation, leaf shape and configuration, and plant form or type. The tool does not facilitate ordering or provide any design guidance or data on floral design compositions. Furthermore, by emphasizing technical horticultural characteristics, such tools are of limited use to consumers lacking a background in horticultural or botanical sciences.

e. Conclusion: Application of Principles Identifies Above Generally to the Multiple Fields of Creative Composition

While the above-detailed breakdown of the challenges facing creative composition exemplifies the particular problems and deficient solutions particular to the floral design industry, it may be readily appreciated that these challenges generally face patrons desiring a commissioned composition in any medium or design field.

Most significantly, none of these solutions provides an effective automated solution for creating a personalized and meaningful creative composition in a satisfactory way. They either rely on the consumer to do extensive research in design and of the nature of the composition components themselves, such as research on flowers, or they thrust the user directly into the role of the designer without sufficiently preparing the user for that role, and despite the fact that many consumers do not necessarily want to act as the designer—they just want to play a meaningful role in creating a personalized and meaningful design without being an artisan themselves.

Thus, it would be desirable to have a solution that allows consumers to merely use natural language to describe a relationship or desired message in plainly understandable layman's terms and to receive, based on that input, a meaningful and personalized composition to create or enhance their relationship with the recipient. It would be further desirable for the solution to present discrete, but guided and meaningful, design choices and recommendations based on that natural language input so the user can meaningfully participate in the design process without undertaking the main role of the designer themselves. It would be further desirable for the solution to complete craftsmanship of the design to allow rendering and delivery of a high-quality, fully executed composition based on the design, without the need for the giver to perform any craftsmanship themselves.

### SUMMARY OF THE INVENTION

The invention is directed to methods and apparatus for using non-technical user input, such as natural language and/or discrete option selection, for the design and/or implementation of a creative composition that reflects personal, symbolic, meaningful, artistic, stylistic, and/or design characteristics specified by a novice user with no prior skill in any art relevant to the creative composition and, but whose design and execution requires no specialized, technical, or skilled input by the user.

Among the many different possibilities contemplated, each embodiment may advantageously comprise methods and systems for soliciting user input from which the system can derive and output a creative composition design, without requiring the user to have any technical knowledge or experience vis-à-vis the composition's field of design. One means of achieving this would be to solicit non-technical input from a user's related to the user's design goals. The system then updates uses the user input to update a design template object assigning to weighted values to various design characteristics of the creative composition design. The system can continue to solicit additional user input until the weighted composition values achieve a certain thresholds necessary to constitute a completed design. The system can then present a composition design to the user for approval or for further refinement. The input options may be attached to specific design values from which a design may be derived.

The design structure may be organized, in one embodiment, as an array of constituent groups or arrays. Each constituent array may relate to a particular composition characteristic and be comprised of an array with fields related to values which may be assigned to that particular characteristic. Each of the characteristic values may be assigned a weighted value which the system supplements or decrements based on user design input. Based on these weighted values, the system may derive a set of design characteristics sufficient to define a completed design.

### BRIEF DESCRIPTION OF THE DRAWINGS

The present invention together with the above and other objectives and advantages may be best understood from the following description of one preferred embodiment of the invention, including the invention illustrations, wherein:

FIG. 1 shows a high-level diagram of an exemplary computing system network on which the present invention may be implemented.

FIG. 2 is a flowchart diagram demonstrating an exemplary routine for creating composition entries and updating databases based on data associated with a design composition.

FIG. 3 is a flowchart diagram demonstrating an exemplary routine for defining and updating an individual user design.

FIG. 4 is a diagram representing the organizational structure of one exemplary embodiment of such a composition database.

FIG. 5 is a diagram representing an example of a database object utilizing this structure.

FIG. 6 is a diagram representing the organizational structure of one exemplary embodiment of such a composition element database.

FIG. 7 is a diagram representing an example of a composition element database object.

It should be understood that the associated drawings and descriptions represent but one exemplary embodiment of the present invention. The ordering of the blocks of the illustrated flow charts could be rearranged or moved inside or outside of various routine loops by one skilled in the art. Likewise, various routines or blocks could be broken into multiple steps for reasons of computational efficiency or ease of maintenance. These illustrations are not intended to limit the scope of the invention.

### DETAILED DISCLOSURE OF THE EXEMPLARY EMBODIMENTS OF THE INVENTION

The present invention relates to methods and computerized systems for soliciting guided user input in the form of natural language responses and/or discrete options and exploiting data related to correlations, associations, relationships, or other couplings or connections between creative compositions, their elements, their properties, and their classifications.

Among the many different possibilities contemplated, each embodiment may advantageously comprise methods for decorative plant arrangement design involving a sequence of input prompts related to one or more aspects of the arrangement design process. The prompts solicit responses, either based on discrete options or natural language input. Alternatively, some embodiments of the system may accept for input image data from which aesthetic trends, color palettes, and other design principles may be discerned. The user input is then related to arrays of data related to design criteria. The input is associated with the design criteria data sequentially to result in a creative composition design. The design is then provided to the user for approval or further editing.

Importantly, the input prompts and user response options must be readily addressable by a layperson with no prior design knowledge, artistic ability, or craftsmanship experience relevant to the composition. The input prompts and user response options must not require the user be motivated by the specific practice of floristry or other artistic design, if their motivation is primarily to convey a specific meaning. At the same time, the input prompts and user response options must accommodate users who do wish to design for a particular aesthetic or décor purpose but are not versed in design of the particular aesthetic discipline in question. Nevertheless, the design resulting from the user response entries should be personalized to the creator and/or recipient based on the creator/designer's design objectives, whether those be aesthetic, meaning-based, or for personal story and relationship without resorting to requiring the user to consider explicit design criteria or technical language or decisions.

Upon completion of the design, the system may output a composition outline, blueprint, visual approximation, video representation, or other description of the design, incorporating the user's input at each decision step of the process.

The system and method may include decision steps relating to one or more facets of decorative plant arrangement, including, without limitation, identifying the arrangement's arrangement type, design classification, structure, size, shape, presence or characteristics of structural components, composite elements or their properties, arrangement style, arrangement density, intended purpose, intended recipient, date of intended use, location of intended use, duration of intended use, plant selection criteria, and/or any other characteristics or criteria relevant to a plant composition's design and implementation.

As a system, the invention may be manifest in a computerized network with a graphical user interface to facilitate the issuance of design decisions and receiving responsive input from a user.

Various objects, features, aspects, and advantages of the present invention will become more apparent from the following detailed description of preferred embodiments of the invention, along with the accompanying drawings in which like numerals represent like components.

### I. System Architecture Overview

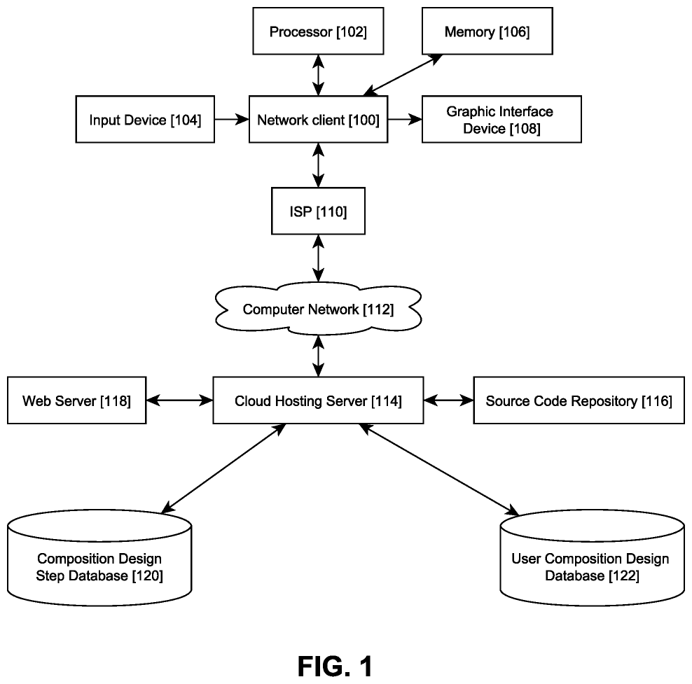

Aspects of the present invention may be implemented on one or more computers executing software instructions. FIG. 1 illustrates an embodiment of the computer system that may be used in one embodiment of the present invention. In the one embodiment, the system of the present invention may be made up of the following components: a network client including a processor, data storage memory, graphical user input display device, alpha-numeric input device, cursor control input device, memory, and/or text output device, a web server computing system, a cloud hosting server, a code source repository, and computer-readable data storage medium(s) containing one or more databases.

These components are combined together to create an architecture for the system in which the server computer system transmits and receives data over a computer network or a standard telephone line. The server computer's central processing unit (CPU) executes sequences of instructions to perform the steps of accessing, receiving, storing, transmitting, downloading, or otherwise manipulating the data, as well as other aspects of the present invention. The CPU functions by executing sequences of instructions stored in memory in the code repository. The CPU memory may be in the form of random-access memory (RAM), read-only memory (ROM), a persistent store, such as a mass storage device, or any combination of these. Execution of the sequences of instructions causes the CPU to perform steps according to embodiments of the present invention.

The present invention is not limited to any specific combination of circuitry and software, or to any particular source for the instructions executed by the server or client computers. In various embodiments of the system, the instructions may be loaded into the server computer memory from a storage device, from one or more other computer systems over a network connection, from the server computer's own memory storage, or any other source. The instructions may be downloaded and interpreted directly by the server CPU or may be executed by an interpreter that transforms the instructions into a format readable to the CPU. In some embodiments, part or all of the instructions are embodied in hardwired circuitry in the system.

FIG. 1 illustrates a computer network system that implements one or more embodiments of the present invention. As demonstrated in FIG. 1, a network server computer 118 is coupled, directly or indirectly, to one or more network client computers 100 through a network 110. Network 110 may be the Internet, a Wide Area Network (WAN), a Local Area Network (LAN), intranet, extranet, wireless network, or any combination thereof.

FIG. 1 includes a client computer 100, which, in an exemplary embodiment may be, by way of example and not limitation, a personal computer (PC) system running an operating system. This operating system may be, by way of example and not limitation, Microsoft Windows, Apple Mac/OS, Apple iOS, LINUX, Android, etc. However, the invention may be implemented on any appropriate computer system running any appropriate operating system, such as a computing device, telephone, personal digital assistant (PDA), a smartphone, an iPhone, a handheld PC, proxy servers, network communication servers, etc.

The client computer 100 includes software and hardware for generating a graphical user interface (GUI) and display signals, for rendering on a GUI display 108. The client computer 100 receives input signals, such as queries, instructions, commands, etc., via an input device(s) 104, which may be a keyboard, a mouse, a touchpad, a scanner, a touch screen, etc.

The client computer may include input/output (I/O) devices (not shown in FIG. 1) such as, by way of example and not limitation, network interface card, modems, network interface, communications port, transceiver, etc. to allow software and data to be transferred between computer system 100 and external devices.

The computer system 100 may also include one or more processors 102. The computer system 100 may also include, e.g., but may not be limited to, memory storage medium or device 106, such as, by way of example and not limitation, random access memory (RAM), a hard disk drive, removable storage drive, and/or any data storage medium which may be read from and written to by the computer system 100.

The network interface between server computer 118 and client computer 100 may also include one or more routers. The routers serve to buffer and route the data transmitted between the server and client computers.

In one embodiment of the present invention, the server computer 118 is a World-Wide Web (WWW) server that stores data in the form of ‘web pages.’ The server computer then transmits the stored web pages as Hypertext Markup Language (HTML) files over the Internet network 112 to one or more of the client computers 100. In one embodiment, the client computer(s) 100 interpret and display the web pages served by the server computer 118 via “web browser” programs. Additional web-based content can be provided to a client computer 100 by separate content providers, such as a supplemental server 114.

In one embodiment of the present invention, server 118 in the system is a server that executes an information retrieval and transmission process. The information retrieval and transmission process involves the receipt and transmission of data from various client computers, such as network client 100, and processes the received data to process requests received over network 112. The information retrieval and transmission process may represent one or more executable program modules or applications stored within cloud hosting server 114 and executed locally within the server. Alternatively, the information retrieval and transmission process may be implemented in a plurality of different program modules, each of which may be executed by two or more distributed server computers coupled to each other, or to network 112 separately. In a further alternative embodiment, information retrieval and transmission process may be stored on a remote storage or processing device coupled to server 118 or network 112 and accessed by server 118 to be locally executed. It should be noted that a network system 114 that implements embodiments of the present invention may include a larger number of interconnected client and server computers than shown in FIG. 1.

Unless specifically stated otherwise, as apparent from the following discussions, it may be appreciated that throughout the specification discussions utilizing terms such as “processing,” “computing,” “calculating,” “determining,” “manipulating,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

According to an exemplary embodiment, exemplary methods set forth herein may be performed by one or more computer processor(s) adapted to process program logic, which may be embodied on a computer-accessible storage medium, which when such program logic is executed on the exemplary one or more processor(s) may perform such steps as set forth in the exemplary methods.

### II. User Interfaces

In order for a user to effectively interact with the system, the system may provide a user interface comprised of GUI objects to facilitate interaction with the system.

In one embodiment of the invention, the system provides two separate user interface GUI formats: an individual user GUI (e.g., for consumers or laypersons interested in participating in the design process) and a system administrator interface (e.g., for those tasked with overseeing the operation of the computer site). Each such interface may enable users, for example, to access the system's database(s) to either query data stored within the database(s), transmit instructions to process and return data stored in the database(s), and/or enter or otherwise manipulate information into the database(s). It is important to note that alternative embodiments of the invention may involve additional, different, or other GUIs specialized for different purposes, such as, for example, GUI objects for florists, GUI objects for floral designers, GUI objects for bridal industry consultants, GUI objects for consumers seeking to acquire plants to use as gifts, GUI objects for specialty users (e.g., brides for meaningful bridal flower compositions), GUI objects for particular occasions (e.g., for planning parties), GUI objects for supply chain participants, such as manufacturers or distributors (e.g., flower farms or vase manufacturers), GUI objects for wholesalers participating in the supply chain (e.g., flower importers or shippers), GUI objects for logistics providers (e.g., flower transporters), GUI objects for delivery drivers for the completed product, etc. Other embodiments of the invention may not include some of the GUI objects described herein such as the creator GUI.

Each of the system's interfaces may employ a combination of instructions to display the GUI interface and enable access to various system functions. Said instructions may be recorded in any computer-readable medium such as, by way of example and not limitation, HTML, PHP, CSS, XHTML, Flash, Python, Javascript, and/or Ajax, etc. It will be understood that the interfaces may be implemented in any computer-readable means which enables convenient and efficient human interaction with the system, including applications, executable program files, and the like.

The individual user (i.e., composition design creator) interface may include, for example, and not by way of limitation, GUI elements providing functionality described more fully below, but generally designed to facilitate posing a series of design options to a user, information (including visual imagery, video, or audio content) necessary to competently complete the design choice and a means of facilitating receipt of user input related to their design choice at that each stage of the series. Individual user GUI objects may also enable users to access detailed information on exemplary plant compositions, plant composition properties, plant composition classifications, plant composition elements, or plant composition element properties should a particular user desire further education on any step of the system, though such information is not required of all users to complete using the system. Additionally, the GUI objects may include functionality enabling users to communicate directly with composition craftsperson's executing the compositions based on the user designs (e.g., florists, designers, artists, etc.) for the purpose of establishing custom composition requests or personalized design composition fulfillment, inquiring regarding current price, design specifications, and the like.

In one embodiment, the system may include an interface for a second class of user, the system administrator. The purpose of the administrator interface is to perform such functions as will facilitate the design process, inspect and maintain system data and databases, and generally perform any maintenance and development as may be desirable to ensure the effective performance of the system. The system administrator interface may include a means for administrator users to execute command and control oversight over the computer site's operations. By way of example, and not limitation, this functionality may include interacting with data contained in the site database(s). The administrator GUI may enable administrators to access and analyze data about users in the system, including their current and historical site navigation activity, their user account details, IP information, etc. The administrative interface may also enable administrator users to analyze data about the system's information flow and load overall. The administrative interface may display and modify user permissions and access of various users to certain content or functionality at a given time.

In one embodiment, the system may include an interface for a third category of user, the decorative plant design artisan. The purpose of this interface is to convey an individual user's composition design to an artisan or craftsperson to actually create a composition based on the user's design. The artisan user's interface may include means for an individual physically constructing a composition based on a composition design created by way of the individual user interface to construct a decorative plant design based on the design creator's specifications. The artisan's interface may include a list of each design choice input by the design creator in the design creator interface. The artisan interface may further include visual composition creation aids, such as a computer-generated visual approximation of the user's design or photographs of past compositions with characteristics in common with those included in the user's design. The artisan's interface may also include lists of specific instructions for executing one or more particular aspects of a user's design choices in the plant composition.

In some embodiments, the artisan's interface may include quality control mechanisms including optical pattern recognition to ensure the artisan's compliance with design guidelines. In some embodiments, the quality control mechanisms may involve quality guidelines established and input by the system administrator and input into the system via the system administrator interface. In some embodiments, the quality control mechanisms may include optical pattern recognition software or other tools to visually match characteristics of a composition with a user's design choices.

In some embodiments, the artisan's or craftsperson's interface may include tools to facilitate communications between the artisan and the individual user who has created a design. This communication may be desirable, for example, to clarify any ambiguities that may exist in the design or based on instructions input by the design creator in the design creator interface. The communication may also be desirable, for example, to allow an artisan to provide particular design guidance or recommendations to ensure an aesthetically pleasing composition.

It will be appreciated by one who is skilled in the art that it may be desirable for the system to include additional interfaces for different classes of users or functions to facilitate different system functions. This description should not be construed as a complete or limiting description of the described invention.

### III. Design Decision Series Overview

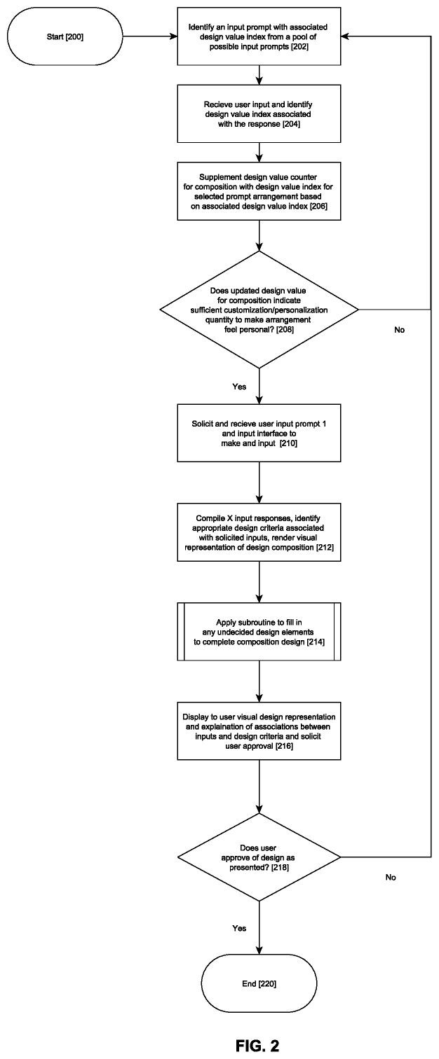

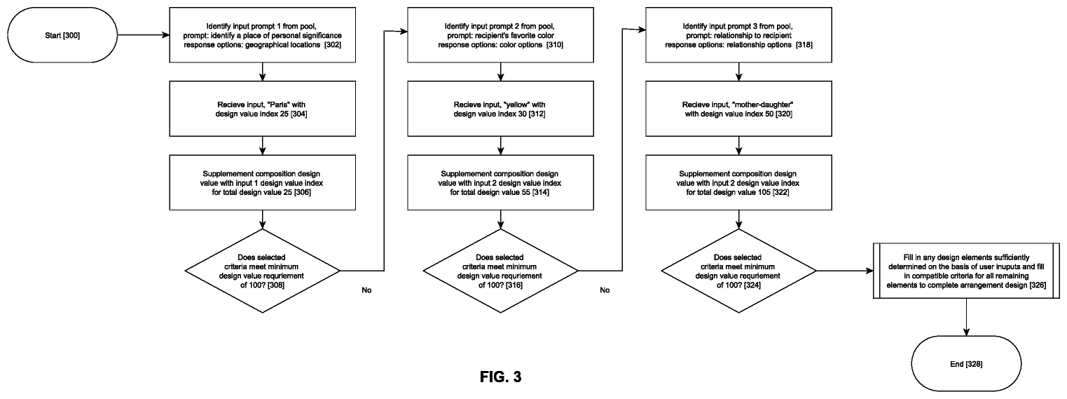

In order to present an individual designer user with a series of design choices and facilitate receipt and processing of user input, the system may involve one or more routines to facilitate presenting the user with a graphical user interface (“GUI”) presenting design choices and facilitating receipt of responses. FIG. 2 is a flowchart diagram demonstrating a template of the functionality of an exemplary embodiment of the invention. FIG. 3 is a flowchart diagram demonstrating an exemplary embodiment of the method's decision series routine execution.

The query in the embodiment illustrated in FIG. 2 includes various processes that coordinate the basic steps of selecting a design input prompt from a pool of possible prompts, presenting the prompt to the user to solicit a response [202], the user's decision is associated with a design value index which indicates the amount of personalization the choice imparts to the design [204], the system supplements the composition's design value with the design value index of the user's selection [206]. If the design value satisfies a minimum threshold for sufficient personalization [208], the system selects design criteria related to those inputs [212] and, if there are any still undetermined design elements, the system applies a subroutine to fill those in with compatible design elements as well [214]. The design is then presented to the user for acceptance [216]. If the user approves, they proceed to the next step [218]. If the user rejects the design, the system continues pulling input prompts from the pool and soliciting additional input before presenting an updated design to the user.

An example of this process is illustrated in FIG. 3, which demonstrates a specific series of input prompts for the creation of a personalized composition of a flower arrangement based on non-technical, personalized user input. The system solicits inputs from the user with three input prompts. Each of the user input selections is associated with an index value. The system is set with a minimum design value of 100 for the design to be considered complete. The first user input selection, Paris [304], has an index value of 25 [306], which fails to meet the 100 value threshold for the arrangement to be considered sufficiently personalized [308]. Accordingly, the system pulls an additional input prompt from the pool [310] and solicits further input, “yellow” [312], with a design index value of 30. This brings the total composition value to 55, which is still below the 100 personalization threshold. Thus, the system pulls a third input prompt [318] and receives the input “mother-daughter” with a design value index of 50, bringing the total composition design value to 105—exceeding the 100 design value threshold [322]. Having passed the threshold, the system applies a generates a design, accounting for the user input prompts [326]. The system then creates a visual representation of the design and presents it to the user for approval. At this phase, the system may provide the user information on the associations between the user inputs and the subsequent design choices, so the user may understand the bases of the design elements in association with the system's user choices. If the user accepts the design as sufficiently personalized, the user may then proceed past the design process. Alternatively, the user may reject the design or request additional personalization opportunities, in which case the system can pull additional input prompts from the request pool.

For those skilled in the art, it will be apparent that the input prompts exemplified in FIG. 3 presented only as an exemplary embodiment of the invention, and the invention could include different steps, different choice options, different input formats, different rules or decisions, different sequences of steps, different orders of choice options, or may otherwise vary in a number of particular system elements without altering its fundamental functionality or jeopardizing its ability to guide users through the plant composition design process.

In one embodiment, the range of user inputs solicited may include, by way of example and not limitation, the occasion or event for which the composition is designed, the nature of the existing or desired relationship between the user and recipient, the aesthetic preferences of the user and/or recipient, significant locations between the user and recipient, etc. In one embodiment of the system, some or all of these prompts solicit input by presenting discrete “multiple choice” style options. In one embodiment of the system, some or all of these prompts may solicit input by presenting the user an open-ended opportunity to provide a language-based response in the user's own discretionary language.

In one embodiment of the system, rather than presenting discrete queries and response options, the system may prompt the user with a more open-ended inquiry and accept a natural language response. The system would identify character or sound strings in the response input. On the basis of identified character or sound strings, the system may update the design index. In the event that the user input fails to provide adequant character strings or sound patterns to meaningfully or sufficiently update the design index, the system may prompt the user to provide further input. In the event that a particular input character string or sound pattern may be programmed to yield more than one design index update possibility depending on context or ambiguity, the system may issue follow up prompts to clarify or determine which of several design index supplements to apply.

In one embodiment of the system, rather than the input formats described above, the system may accept input in the form of image or video data. The system maybe configured to identify aesthetic prompts from the input image or video data. The prompts may include identification of particular elements, such as flowers or foliage, on the basis of which the design index may be updated. Likewise, prompts may identify color patterns or combinations, configuration of design elements and patterns all of which may yield meaningful aesthetic data on the basis of which the system may supplement the user's design index.

Regardless of which input the user provides, it is not necessary that one or more images, natural language inputs, or other forms of input provide sufficient design index supplementation to achieve the threshold sufficient to present the user with a complete design, rather, based on the patterns, information, or existing design index status, the system may issue prompts for additional responses to further update the design index.

In one embodiment, the range of design decisions which may be applied based on user input include, by way of example and not limitation, design look, composition structure, size and shape of parts of a composition (e.g., shower, radiation, body, handle, accessories of an arrangement, etc.), size and shape of the overall composition, arrangement of components, intended use or purpose for composition, intended recipient of composition, composition use date, composition use venue, and other composite elements within the composition, choice of particular plants and other elements in the composition, including based on the properties of those elements, such as size, shape, width, color, growing season, commercial availability, price, etc., and among many other possible composition properties.

### IV. Structure of Design Composition within the System

As identified in FIG. 2 and FIG. 3, the system generates a composition design based on user input. The composition design may be comprised of an array with fields related to composition characteristic categories and values within those arrays related to the particular composition aspects selected as associated with the user inputs.

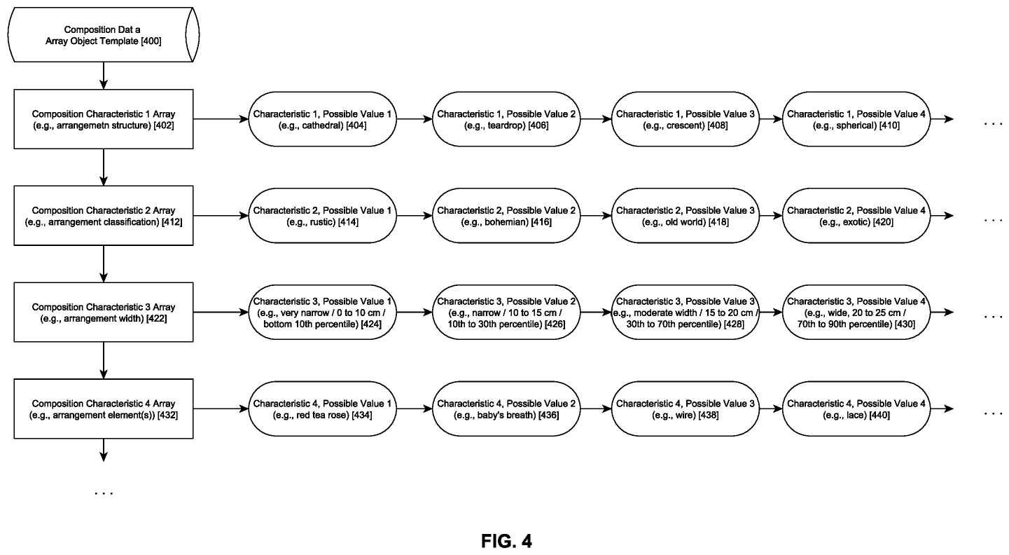

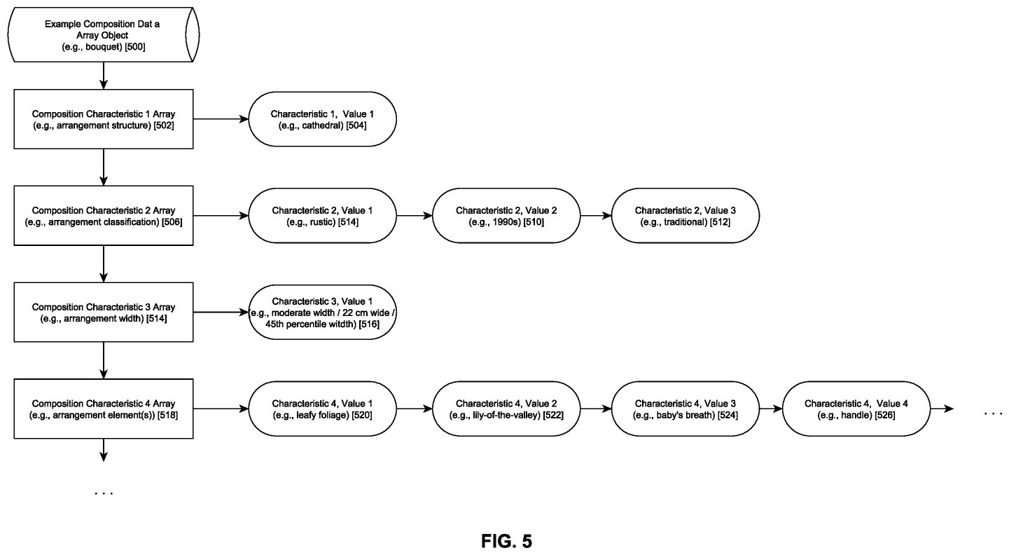

FIG. 4 is a diagram representing the organizational structure of one exemplary embodiment of such a composition database. FIG. 5 is a diagram representing an example of a database object utilizing this structure.

In one embodiment, the database objects may consist of arrays of data representing information related to the composition represented by the array [402, 412, 422, 432]. For each such array, a template is defined with each data array position representing a separate, internal array listing a category of characteristics [402, 412, 422, 432], and the positions in the internal array representing the particular characteristics possessed by the collection which fall under the collection array position's characteristic category [404, 406, 408, 410, 414, 416, 418, 420, 424, 426, 428, 430, 434, 436, 438, 440].

By way of example, and not limitation, it is helpful to consider an example of such an array structure related to a floral arrangement composition [FIG. 5]. The collection database object is comprised of a composition array containing internal arrays related to the classes of characteristics that may describe the qualities of a floral composition [502, 506, 514, 518]. Thus, the composition array may consist, for example, of an identification array, an image array, a design classification array, a composition element array, a bouquet structure array, a bouquet size array, a bouquet body array, a bouquet element array, etc. and any other arrays for characteristics associated with a bouquet composition, with separate arrays defined for a variety of characteristics of a bouquet [502, 506, 514, 518].

For a particular composition array object, these internal arrays may then be populated with the specific, individual characteristics related to or representative of that bouquet composition [504, 508, 510, 512, 516, 520, 522, 524, 526]. For example, a rustic bouquet may be populated with zero or more names or identification number in the identification array (e.g., a name or identification number for the bouquet composition, etc.), zero or more graphic representations of the composition in the image array (e.g., photographs or drawings of the composition, etc.), zero or more design classifications (e.g., rustic, whimsical, etc.) in the design classification array [506], zero or more structures (e.g., crescent, cathedral, hand-tied, cascade, etc.) in the structure array [504], zero or more widths (e.g., narrow, medium, wide, etc.) in the size array [516], and so forth for as many internal characteristic arrays as may be defined within such a particular embodiment of the invention.

To facilitate the entry of composition objects, one embodiment of the system may rely on a composition template [FIG. 4]. Such a composition template could be defined as a composition array object delineating all characteristic category arrays defined in the embodiment and all values within each internal composition category array as defined within that embodiment of the invention. Each possible internal composition value would be assigned a “tag” within the system to facilitate correlation, association, or grouping of database objects. In such an embodiment of the system, each possible value of attribute would be segregated into a number of potential assignable characteristics for each composition characteristic category. For example, for a composition category related to “width,” the composition category template may be delineated into the assignable values, “vary narrow,” “narrow,” “moderate,” “wide,” and “very wide,” each of which may be understood to refer to a particular range of width in inches or centimeters [422, 424, 426, 428, 430].

Alternatively, a particular composition array element may be configured to accept alpha-numeric values representing a measurement, range, amount, or other value [424, 426, 428, 430]. In such an embodiment, for example, a composition category “width” may be configured to accept values corresponding to any numeric value representing a measurement width, for example, “12 inches,” “16 inches,” or “25 centimeters,” etc. Optionally, descriptive values or tags may be assigned to value ranges, for example, “very narrow” bouquets may consist of bouquets between 0 and 10 centimeters wide; “narrow” bouquets may consist of bouquets between 10 and 15 centimeters wide, moderate bouquets may consist of bouquets between 15 and 20 centimeters wide, etc. Alternatively, descriptive value tags may be assigned relatively based on a bouquet's value in comparison to other bouquets in the collection, for example, “very narrow” bouquets being assigned as bouquets in the lowest 10% of width in the collection, “narrow” bouquets being assigned as bouquets with a width between the bottom 10% and 30%; “moderate” width description being assigned to bouquets from the 30% to 70% width relative to the other bouquets in the collection, etc.

In one embodiment, the composition characteristic array may include as one of its elements a separate array listing the composition elements from which the composition is comprised [432, 434, 436, 438, 440]. The composition element array may relate to the individual composition elements comprised in the composition element database [128, 518, 520, 522, 524, 526].

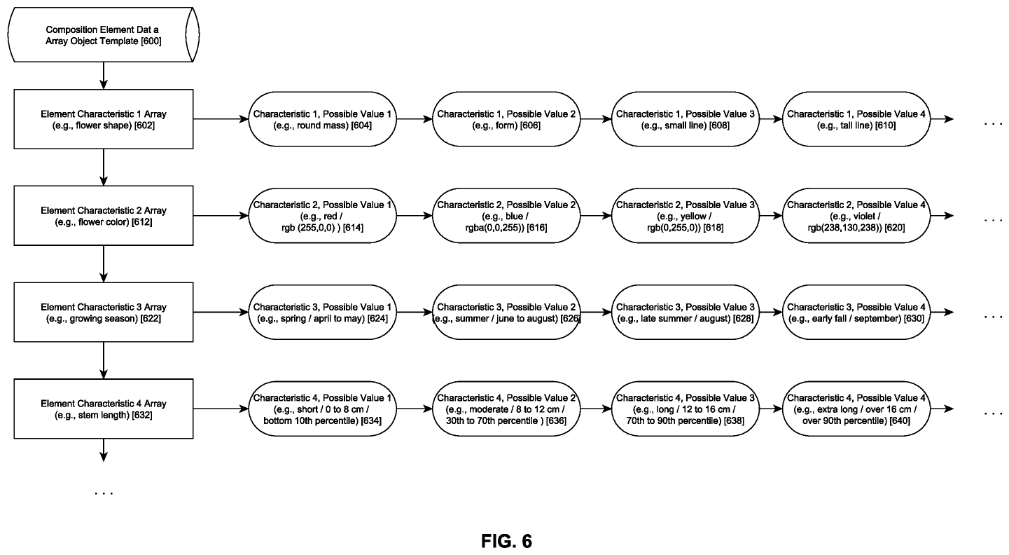

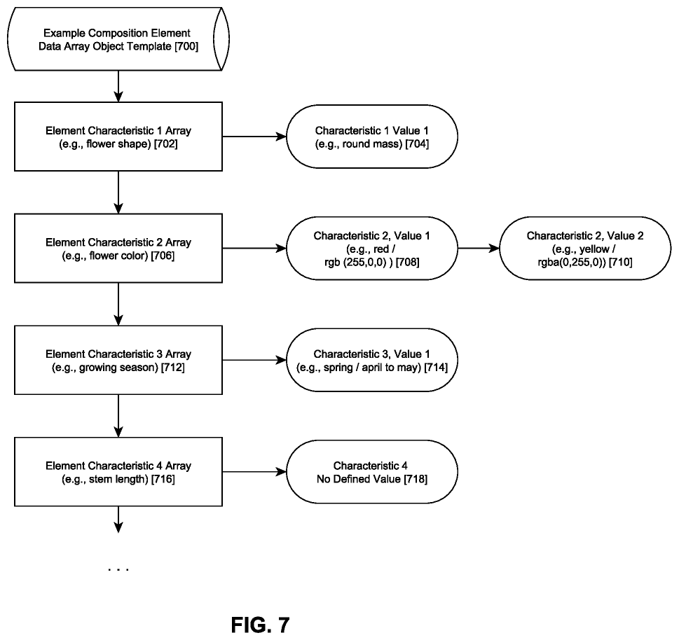

In one embodiment, the system may maintain a database of objects related to composition elements, which, together, comprise a collection of those components, materials, or elements which are or may be used to compose a creative composition. FIG. 6 is a diagram representing the organizational structure of one exemplary embodiment of such a composition element database. FIG. 7 is a diagram representing an example of a composition element database object.

In one embodiment, such a composition element database may be organized similarly to the composition database described above [FIG. 4, FIG. 5]. Composition element database objects may consist of arrays of information representing data regarding the composition element represented by the array [FIG. 6, 602, 612, 622, 632]. For each such array, a template [FIG. 6] is defined with each data array position representing a separate, internal array listing a category of characteristics [602, 612, 622, 632], and the positions in the internal array representing each of the possible characteristic values possessed by an element which falls under the element array position's characteristic category [604, 606, 608, 610, 614, 616, 618, 620, 624, 626, 628, 630, 634, 636, 638, 640].

By way of example, and not limitation, it is helpful to consider an example of such an array structure related to floral arrangement composition elements [FIG. 7]. The collection database object is comprised of a composition element array containing internal arrays related to the classes of characteristics that may describe the qualities of floral composition elements [702, 706, 714, 718]. Thus, the composition element array may consist, for example, of an identification array, an image array, a design classification array, a composition element array, a bouquet structure array, a bouquet size array, a bouquet body array, a bouquet element array, etc., and any other arrays associated with characteristics of bouquet element characteristics, with separate arrays defined for a variety of characteristics of a bouquet element [702, 706, 714, 718].

For a particular composition element array object, these internal arrays may then be populated with the specific, individual characteristics related to or representative of that bouquet composition [704, 708, 710, 714, 718]. For example, a tea rose may be populated with zero or more names or identification number in the identification array (e.g., a name or identification number for the flower, such as “tea rose,” etc.), zero or more graphic representations of the rose in the image array (e.g., photographs or drawings of the flower, etc.), zero or more flower shape properties (e.g., small mass, etc.) in the flower shape array [702, 704], zero or more colors (e.g., red, yellow, etc.) in the color array [706, 708, 710], zero or more growing seasons (e.g., spring, May, April to May, etc.) in the growing season array [712, 714], zero or more stem lengths (e.g., short, long, 0 to 10 cm, 10th to 30th percentile, etc.) in the stem length array, and so forth for as many internal element characteristic arrays as may be defined within such a particular embodiment of the invention.

To facilitate the entry of composition element objects, one embodiment of the system may rely on a composition template [FIG. 6]. Such a composition element template could be defined as a composition element array object delineating all characteristic category arrays defined within the system and all characteristic values within the internal composition category arrays as is defined within that embodiment of the invention. Each defined internal composition value could be assigned a “tag” within the system to facilitate correlation, association, or grouping of database objects. In such an embodiment of the system, each defined characteristic category array would be segregated into a number of potential assignable characteristics for the characteristic category. For example, for a composition element category related to “stem length,” the category template may be delineated into the assignable values, “vary short,” “short,” “moderate length,” “long,” and “very long,” each of which may optionally be understood to refer to a particular range of stem length in inches or centimeters [632, 634, 636, 638, 640].

Alternatively, a particular composition element array may be configured to accept alpha-numeric values representing a measurement, range, amount, or other value [634, 636, 638, 640]. In such an embodiment, for example, a composition category “stem length” may be configured to accept values corresponding to any numeric value representing a measurement width, for example, “8 inches,” “12 inches,” or “16 centimeters,” etc. Optionally, descriptive values or tags may be assigned to value ranges, for example, “very short” stems may consist of flowers with stems between 0 and 10 centimeters long; “short” stems may consist of flowers with stems between 10 and 15 centimeters long, moderate stems may consist of flowers with stems between 15 and 20 centimeters long, etc. Alternatively, descriptive value tags may be assigned relatively based on a bouquet's value in comparison to other bouquets in the collection, for example, “very short” stems being assigned as flowers with stems in the lowest 10% of length in the composition element collection, “short” bouquets being assigned as flowers with stems between the bottom 10% and 30% of stem length; “moderate” stems being assigned to flowers between 30% to 70% stem length relative to the other bouquets in the collection, etc.

### V. Subroutines Deriving Design Elements with Associated User Input

As demonstrated in FIG. 2 and FIG. 3, the system solicits nontechnical input from the user based on user history and personal information on the user, recipient(s), and/or the relationship between them. Based on these inputs, the system returns associated design composition characteristics. In one embodiment of the system, such associations may be derived from a database associating possible inputs with design criteria.

Each potential user input option may be associated with an array of associations with specific design criteria. A particular input option may include indexing associations with multiple different design criteria. Such associations may be positive or negative. As each piece of user input is entered, the system updates a design composition array. The design composition array is updated by supplementing an array of weighted values for each design option.

For example, the possible user input “yellow,” the system may include, by way of example and not limitation, the following weighted values for certain design criteria in the case of an example for a floral arrangement composition:
(1) CRITERIA: Design Look—Whimsical+50; Garden −25; Exotic −25;
(2) CRITERIA: Size—large+25, small −10;
(3) CRITERIA: Composition Elements—yellow rose+100; red rose −50, etc.

For further example, the possible user input “Paris,” could be associated with the following weighted values:
(1) CRITERIA: Design Look—Garden+50, Whimsical+10, Exotic −15;
(2) CRITERIA: Color Scheme—pastel+100, dark −35;
(3) CRITERIA: Size—medium+25, small −20;

By way of example, in the event that the user provided the input “yellow” and “Paris,” the system would then maintain the following weighted array for composition data:
(1) CRITERIA: Design Look—Whimsical+60; Garden+25; Exotic −40;
(2) CRITERIA: Size—large+25, medium+25, small −30;
(3) CRITERIA: Composition Elements—yellow rose+100, red rose −50;
(4) CRITERIA: Color Scheme—pastel+100, dark −35.

Employing these weighted values, in one embodiment of the system, when processing user inputs to return a design, the system could remove all negative values, which would be below the threshold for possible inclusion in the design, and then select specific composition values by selecting between the remaining elements selecting between them at a probability based on their relative weighting. For example, the odds the system would include each of the following criteria could be as follows:
(1) CRITERIA: Design Look—Whimsical (60/85), Garden (25/85);
(2) CRITERIA: Size—large (25/50), medium (25/50);
(3) CRITERIA: Composition Elements—yellow rose (100/100);
(4) CRITERIA: Color Scheme—pastel (100/100).

Having selected criteria based directly on those user-input-weighted values, the system could fill out the remaining composition characteristics similarly by using the selected composition values and to identify compatible composition or design selections for any remaining, unfilled positions. Continuing with the above example, having returned the values:
(1) CRITERIA: Design Look—Whimsical;
(2) CRITERIA: Size—Large;
(3) CRITERIA: Composition Elements—yellow rose;
(4) CRITERIA: Color Scheme—pastel;
   The system could fill in the remaining design criteria with the following selections which are compatible with those selections:
(5) CRITERIA: Arrangement Style—naturally mixed (compatible with above elements and positively correlated with Whimsical);
(6) CRITERIA: Additional Composition Elements—blue snapdragons (compatible with above elements and positively correlated with Whimsical and pastel color schemes);
(7) CRITERIA: Native origin—Mediterranean—(positively correlated with large and yellow rose), etc.

It is important to note that alternative embodiments of the invention may organize and maintain one or more databases differently. Some embodiments of the invention may maintain a single database organizing all composition data, including data on design classifications, composition properties, composition elements, or composition element properties.

### VI. Data Aggregation and Correlation Routine Overview

In one embodiment of the system, the above listed weighted correlations could be generated based on historical design data. In one embodiment, the correlation or aggregation data included in the database(s) consists of a series of correlations between one database object and one or more database objects. In one embodiment, these correlations relate to the prevalence of particular characteristics, elements, or other identifiable qualities together with a particular design classification, composition, composition property, composition element, or composition element property. In one embodiment, these correlations relate to the frequency of appearance of a property, element, or another object in some number of compositions as compared to the total number of compositions, or a sub-set of compositions with a particular characteristic or property.

Accordingly, as one or more database is augmented with additional compositions, the correlation or association data may be updated to reflect the addition of compositions bearing certain combinations of properties, characteristics, elements, or classifications.

By way of example, consider one exemplary embodiment of the system with a collection comprised of 100 compositions designs comprised of flower arrangements. In such a collection, consider that ten of the objects or ten percent of the total are assigned a design classification “rustic” and twenty of the collections include the bouquet composition element “tea rose.” Consider that of the bouquet compositions designated “rustic,” five contain the element “tea rose.” In such an embodiment, the system may contain correlation or association information to indicate that “rustic” bouquets maintain a rate of 10% prevalence, tea roses, as a bouquet element, are included at a rate of 20% prevalence, rustic bouquets with tea rose elements comprise 5% of the total collection, 50% of rustic bouquets in the collection contain tea rose elements, and 25% of bouquets with tea roses are designated with the “rustic” design classification.

Further considering the above example, consider the case in which 100 new arrangement compositions are added to the collection. These compositions include twenty “rustic” compositions, five compositions including “tea rose” composition elements, and five compositions that include tea roses and are designated the “rustic” design classification. Following this addition, the system's correlation or association data entries would be updated and the resulting associations would now include a rate of 15% prevalence of “rustic” classified compositions (30 of 200), a 12.5% prevalence of compositions including the “tea rose” element (25 of 200), a 5% prevalence of “rustic” classified compositions which comprise the “tea rose” element (10 of 200), a 33.33% prevalence of “tea rose” elements in bouquets classified as “rustic,” and a 40% rate of bouquets containing “tea rose” to be classified as “rustic.”

In one embodiment of the system, each association or correlation will be updated by employing an algorithm that periodically inspects each composition and its qualities, and recalculates the prevalence of each database object with one or more other database objects in the collection. In one embodiment, this algorithm may be employed each time a database object is updated or a new object is added to a database. In another embodiment of the system, the algorithm may be employed at regular intervals to update the correlation data entries. In another embodiment of the system, the set of associations is updated manually and may be entered into the system by a system administrator.

### VII. Alternative Embodiments

It will be understood that various modifications can be made to the embodiments of the present invention herein disclosed without departing from the spirit and scope thereof. The invention may be directed toward one or more computer systems capable of carrying out the functionality described herein and may find applicability in any computing or processing environment with any type of machine that is capable of running machine-readable instructions. For example, the principles of the invention may apply to other computer applications, such as other mainframes, minicomputers, network servers, personal computers, handheld mobile units or computing devices, as well as other electronics applications. Also, various modifications may be made in the configuration of the parts and the steps of the process. Therefore, while the discussion herein focuses on a particular application, it should be understood that the invention is not limited to the particular hardware designs, software designs, communications protocols, performance parameters, or application-specific functions disclosed herein.

A person skilled in the art will appreciate that the method and system of the present invention may be utilized in environments other than the Internet. The invention may be implemented using computer programming or engineering techniques including computer software, firmware, hardware, or any combination or subset thereof. Any such resulting program, having computer-readable code means, may be embodied or provided within one or more computer-readable media, thereby making a computer program product, i.e., an article of manufacture, according to the invention. The computer-readable media may be any data storage device that can store data, which thereafter can be read by a computer system, such as, for example, a fixed (hard) drive, diskette, optical disc, magnetic tape, semiconductor memory such as read-only memory (ROM), etc., or any transmitting/receiving media such as the Internet or other communications network or link.

Likewise, while the embodiments described herein are described in terms of interface programs that utilize web server and web browser programs, these document production processes may be implemented as proprietary or dedicated software programs that communicate over public or private computer networks coupling the on-line project management system to users.

The computer-readable storage medium containing the computer code may be made, used, and/or distributed by executing the code directly from one medium, by copying the code from one medium to another medium, or by transmitting code over a network. An apparatus for making, using, or selling the invention may be one or more processing systems including, but not limited to, a central processing unit (CPU), memory, storage devices, communication links and devices, servers, I/O systems, including software, firmware, hardware or any combination or subset thereof, which embody the invention as set forth in the claims. User input may be received from the keyboard, mouse, pen, voice, touch screen, or any other means by which a human can input data to a computer, including through other programs such as application programs.

All or part of the system can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Specifically, it will be appreciated that one or more of the methods employed in the above-described embodiment of the invention may be realized as computer-executable code created using a structured programming language, object-oriented programming language, markup language, or any other high-level or low-level programming language that may be stored, compiled or interpreted to run on a data processing apparatus, as described above, as well as heterogeneous combinations of processors, processor architectures, or combinations of different hardware and software, including, without limitation, C, C++, Visual Basic, HTML, XHTML, Java, VBScript, Jscript, BCMAscript, Javascript, DHTM1, XML, CGI, ASP, assembly language, hardware description languages, or database programming languages and technologies, including, without limitation, MySQL, Microsoft SQL Server, IBM AS 400 or the like.

All or part of the computer system can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the plant search and indexing system, or any combination of such back-end, middleware, or front-end components. The components of the system can be interconnected by any form or medium of digital data communication, e.g., a communication network. Examples of communication networks include a LAN and a WAN, e.g., the Internet.

Method steps associated with the system can be rearranged and/or one or more such steps can be omitted to achieve the same, or similar, results to those describe herein. Individuals skilled in the art will easily be able to combine the software created as described with appropriate general purpose or special purpose computer hardware to create a computer system or computer sub-system embodying the method of the invention. Individuals skilled in the art will also envision other modifications within the scope and spirit of the present invention as defined by the drawings and descriptions set forth herein.

Therefore, it should be understood that the breadth and scope of the described invention should not be limited by any of the above-described exemplary embodiments. The examples and embodiments described herein are for illustrative purposes only and that various modifications or changes in light thereof will be suggested to persons skilled in the art and are to be included within the spirit and purview of this application and the scope of the described invention. The breadth and scope of the described exemplary embodiments should be defined only in accordance with the claims of any patent application(s) claiming the priority and benefit of this provisional application, which claims are incorporated herein by reference.

What is claimed is:

1. A method of creative composition design, comprising: a means of soliciting user input; a means of deriving a creative composition design from the solicited user input; and a means of presenting the derived creative composition design to the user from whom the non-technical user input was solicited.

2. The method of claim 1, comprising: an array of data correlated to creative composition design characteristics, which may be employed to derive a creative composition design.

3. The method of claim 1, comprising a series of prompts to solicit the user input from the user.

4. The method of claim 1, comprising a means of associating the solicited user input with characteristics of a creative composition design.

5. The method of claim 1, wherein the solicited user input is comprised of a selection from a set of input response options presented to the user.

6. The method of claim 1, wherein the solicited user input is comprised of natural language input.

7. The method of claim 1, wherein the solicited user input is comprised of image date.

8. The method of claim 1, wherein the means of deriving the creative composition design from the solicited user input is comprised of weighted values associated with design characteristic values.

9. The method of claim 8, wherein the weighted values are derived from historical user data.

10. The method of claim 8, wherein the weighted values are derived from design principles relevant to the creative composition design's field of technical expertise.

11. The method of claim 1, wherein the creative composition design is comprised of an array of characteristics related to the creative composition.

12. The method of claim 11, wherein the array of characteristics is derived from weighted values for various characteristics yielded from the user input.
